(19) United States
(12) Patent Application Publication
(10) Pub. No.: US 2008/0226092 A1
(43) Pub. Date: Sep. 18, 2008

(54) Audio method and system

(76) Inventors: Mark W. Minne, Corvallis, OR (US); Michael D. Derocher, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/724,906

(22) Filed: Mar. 15, 2007

(51) Int. Cl. H04B 3/00

(52) U.S. Cl. 381/77

(57) ABSTRACT

A method of providing an audio signal to an audio output device may include receiving an audio signal and providing the audio signal simultaneously to audio output devices in first and second physical environments so as to appear not to emanate from an individual depicted on a display in either the first environment or the second environment.

### FIELD OF THE INVENTION

The present invention relates to audio signals.

### BACKGROUND OF THE INVENTION

In remote video conferencing, one or more individual participants are located in a first location, such as a room, and one or more individual participants are located in at least one other location. One or more cameras are located at each location to obtain images of one or more participants in at least two locations, which are translated into signals, transmitted to the other locations, and then displayed. Simultaneously, one or more microphones in each location convert sound from the location into audio signals, which are provided to audio output devices, such as speakers, in the other locations. Cameras, microphones, speakers and video displays may be provided at each location so that the image of each participant is displayed in a particular location, such as on a particular video display in other locations, and the voice of the participant may emanate from one or more speakers so as to be associated directionally with the displayed image of the participant.

There are occasions in remote video conferencing where audio is in the form of something other than the voice of a participant whose image is on a video display. For example, a participant, such as a help desk attendant, may not be represented on a video display. By way of further example, audio from recorded media may be played for all participants to hear.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts and:

FIG. 1 shows a schematic diagram of a system according to an embodiment;

FIG. 2 is a schematic diagram of a system according to an alternative embodiment;

FIG. 3 is a process flow diagram of a process according to an embodiment;

FIG. 4 is a process flow diagram of a process according to an alternative embodiment.

FIG. 5 is a schematic diagram of a system according to an alternative embodiment.

FIG. 6 shows an exemplary video display, with exemplary displayed images, and speaker array in an embodiment.

### DETAILED DESCRIPTION OF THE PREFERRED EMBODIMENTS

The following description of the preferred embodiments is merely by way of example and is in no way intended to limit the invention, its application, or uses.

Particularly in video conferencing with the capability of displaying an image of more than one individual participant in each location, there may be one or more video display screens and audio output devices, such as speakers. In some embodiments, corresponding speakers may be associated with each remote participant. Alternatively, one or more arrays of speakers may be provided. The speakers may receive signals so as to give the impression that a voice emanates from the individual depicted on the video screen. Thus, the location cues associated with an in-person meeting may be provided in a teleconference.

In an implementation of video conferencing known as telepresence, the image and voice of remote participants are provided in a manner to provide the impression that the remote participant is present. Telepresence may provide an environment that appears to immerse the participant, and provides the impression of available eye contact with participants in a remote location. For example, the image of each remote participant may be presented at life size on a video display. Speakers may be provided to give the impression that the voice of the remote participant appears to emanate from substantially the same location as the image of the remote participant. This effect may be referred to as a directional presence. Further elements that may exist in telepresence include fluid motion in displayed images, and accurate colors of displayed people and objects, including accurate display of flesh tones. Still further elements that may exist in telepresence may include quality of lighting, acoustics and video technology similar to those used in professional television and film studios, and a consistency of impression of quality between multiple locations.

There are occasions when a person who is not depicted on a video display speaks to the participants. For example, a call attendant providing help desk services may speak at one or more times during the course of a video teleconference, but a call attendant is not ordinarily depicted on a display. If the voice of a person who is not depicted on a display emanates from a speaker or speakers so as to appear to emanate from an individual depicted on a display, then the participants will tend to be confused as to who is speaking. If the voice of an individual whose image is not displayed is output from a speaker or set of speakers is that is at a position not associated with a display of an individual, the participants' attention will be directed to the position of the speakers.

There are also occasions when sound provided by media is furnished to the participants. For example, a video may be played, with audio, for all participants on a video display provided for this purpose in the various locations. If the audio associated with the video emanates from speakers associated with an image of one of the participants, the effect will be confusing for the remaining participants.

In implementations of video conferencing employing, for example, a single desktop computer system or a single laptop computer system at each location, there are also occasions when audio is provided that is not associated with a participant depicted on the display. By way of example, the audio may be in the nature of an audio track of a video from recorded media. The audio may be, by way of further example, the voice of a participant whose image is not provided.

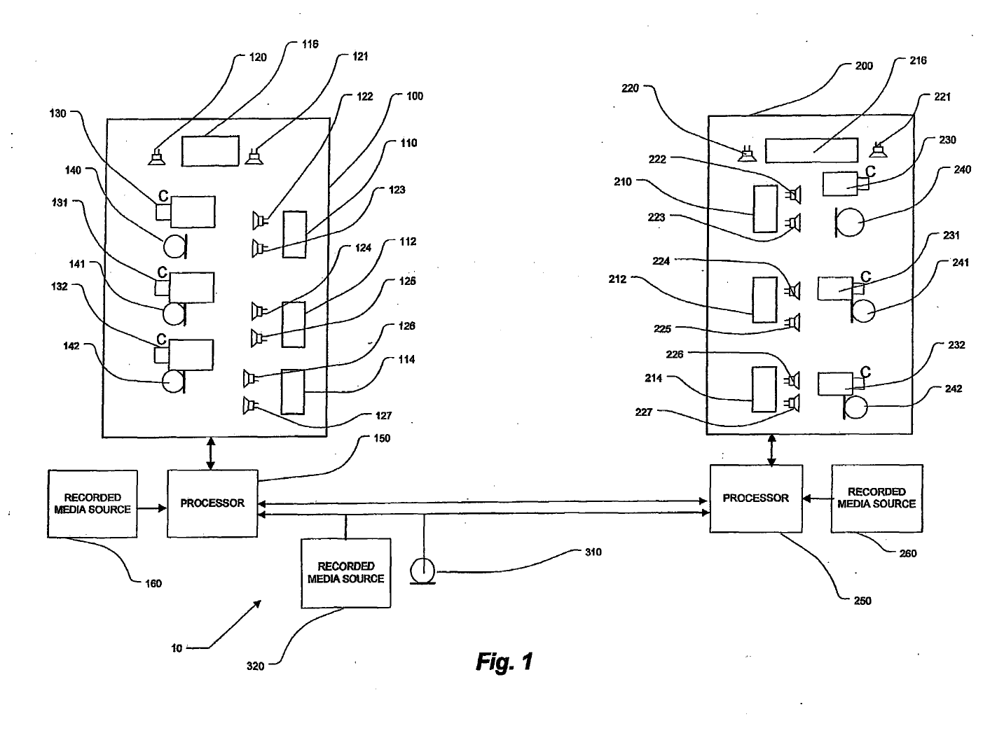

Referring now to FIG. 1, there is shown an embodiment of a video conferencing system 10. System 10 provides video conferencing between first environment 100 and second environment 200. First and second environments 100 and 200 may be spaces suitable for human occupation, and may be rooms. In this example, both first environment 100 and second environment 200 are configured for video conferencing among participants people in each room, for a total of six participants. The capability is provided to display an image of each of the three participants in each environment on displays in the other environment. First environment 100 is shown having three video display screens 110, 112, 114, positioned side-by-side, each of which is associated with a pair of speakers, 122, 123, or pair 124, 125, or pair 126, 127. First environment 100 also includes three video cameras 130, 131, 132. Each video camera has an associated microphone 140, 141, 142. First environment 100 also includes a further video display 116 with associated speakers 120, 121.

Similarly, second environment 200 has three video display screens 210, 212, 214 positioned side-by-side, and each associated with a pair of speakers: 222 and 223; 224 and 225, and 226 and 227. Second environment 200 has three cameras 230, 231, 232, each associated with a microphone 240, 241, 242. Second environment 200 further has a video display 216, and associated speakers 220, 221.

Display screens 110, 112, 114, 116, 210, 212, 214, 216 may be various forms of display apparatus, such as liquid crystal or gas discharge display panels, projection displays, or cathode-ray tube (CRT) displays. The provided speakers may be any type of audio speaker. The cameras may be any type of video camera, and may include digital video cameras which output a stream of data defining uncompressed frames of video in digital format. It will be appreciated that the numbers of display screens, speakers and microphones are exemplary, and that more or fewer of each may be provided. It will also be appreciated that two environments are exemplary, and that additional environments may be provided.

It will be appreciated that the provision of one display screen for each participant is merely exemplary, and there may be alternative arrangements of display screens. By way of example, a single display screen, on which images of one or more participants in a given area of an environment are depicted, may be provided. It will also be appreciated that the relationship between cameras and participants, and between cameras and displays, is merely exemplary. One or more cameras may be provided for each environment, so that multiple participants appear in one camera view. More than one participant may be positioned in each camera's field of view. Image information from multiple cameras may be combined to provide a single image.

It will be appreciated that the relationship between speakers and images is merely exemplary. By way of example, an array of speakers may be provided in each environment, and the output sound provided so as to provide a directional association between the sound output and the image. It will also be appreciated that the relationship between microphones and cameras is merely exemplary. By way of example, an array of microphones may be provided in each environment to receive the sound.

Recorded media source 160 is provided associated with first environment 100. Similarly, recorded media source 260 is provided associated with second environment 200. A recorded media source may also be provided that is not associated with either of environments 100, 200. A recorded media source may be any recorded medium and device capable of providing an output signal, and may include, by way of example, DVD's in a DVD player or personal computer, CD's in a CD player or personal computer, magnetic media, such as cassettes or hard drives, in a suitable player, and other devices which store information for machine retrieval. Recorded media source 160 provides an output signal to processor 150 associated with first environment 100. Recorded media source 160 may be, by way of example, a computer located in first environment 100. Recorded media source 260 provides an output signal to processor 250 associated with first environment 200. Recorded media source 260 may be, by way of example, a computer located in second environment 200.

Audio input may also be received from a location not associated with either first environment 100 or second environment 200. For example, audio input may also be received at microphone 310. Microphone 310 may be located remotely from either first environment 100, second environment 200, or remotely from both environments. Recorded media source 320 may also be located remotely from both environments.

In a method of operation, audio and video received at cameras and microphones in first environment 100 is transmitted to second environment 200 and displayed on display screens and output via the speakers. Simultaneously, audio and video received at cameras and microphones in second environment 200 is transmitted to second environment 100 and displayed on display screens and output via the speakers. Signals from cameras and microphones in first environment 100 may be output to processor 150 for formatting for transmission. Formatting for transmission may include tagging, encoding and compression according to a suitable format, such as a suitable MPEG format. Signals from recorded media source 160 are also provided to processor 150 for tagging, encoding and compression. The suitably tagged, encoded and compressed signals are transmitted to processor 250 for decoding, decompression, and providing, in accordance with tag information, to appropriate video displays and speakers. Processor 150 may tag the signals from recorded media source 160 with tags that indicate to processor 250 that the audio signals are to be output so as to appear not to emanate from an individual depicted on a display. By way of example, the tags associated with the signals from recorded media source 160 may indicate to processor 250 that the signals are to be output as out-of-phase stereo signals. Similarly, processor 250 may tag the signals from recorded media source 260 with tags that indicate to processor 150 that the audio signals are to be output so as to appear not to emanate from an individual depicted on a display, and, by way of example, that the audio signals are to be output as out-of-phase stereo signals.

Signals from recorded media source 160 are also output by processor 150 to first environment 100. Processor 150 causes audio signals from recorded media source 160 to be output so as to appear not to emanate from an individual depicted on a display, such as by providing the signals as out-of-phase stereo signals to one or more pairs of audio output devices in first environment 100. Processor 250 causes audio signals from recorded media source 160 to be output so as to appear not to emanate from an individual depicted on a display, such as by providing the signals as out-of-phase stereo signal to one or more audio output devices in second environment 200, simultaneously with the output in first environment 100. By way of example, processor 150 may cause audio signals from recorded media source 160 to be output by speakers 120, 121 in an out-of-phase stereo manner, and processor 250 may cause audio signals from recorded media source 160 to be output by speakers 220, 221 in an out-of-phase stereo manner. In an out-of-phase stereo signal, two channels are provided, but the signals are not synchronized in phase. The signals may be 180 degrees out-of-phase, or may be out-of-phase by a lesser amount. As the output is out-of-phase, participants in both first environment 100 and second environment 200 will not have an impression of the sound emanating from a particular location in either environment.

In a teleconference, each of video display devices 210, 212, 214 may have appearing thereon an individual located in first environment 100. By way of example, an individual located in front of camera 130 may appear on display 210. The voice of the individual located in front of camera 130 may be detected by microphone 140, and output by speakers 222, 223 collocated with display 210. The signal for the individual's voice may be provided as a signal other than an out-of-phase stereo signal. The signal for the individual's voice may be output as an in phase stereo signal. Thus, participants in second environment 200 have the impression that the voice of the individual located in front of camera 130 is emanating from a location near display 210. An individual located in front of camera 131 may appear on display 212. The voice of an individual located in front of camera 131 may be detected by microphone 141, and output in phase by speakers 224, 225, collocated with display 212. An individual located in front of camera 132 may appear on display 214. The voice of an individual located in front of camera 132 may be detected by microphone 142 and output in phase by speakers 226, 227.

Similarly, if each environment includes an array of microphones and an array of speakers, the voice of an individual in the first environment may be detected by one or more microphones in an array in the first environment, and output by one or more speakers in a speaker array in the second environment, so as to provide a directional presence associated with a corresponding image. The output from the various speakers will be in phase, consistent with a directional impression. The voice of an individual in the second environment may be detected by one or more microphones in an array in the second environment, and output by one or more speakers in a speaker array in the first environment, so as to provide a directional presence associated with a corresponding image of the speaker.

Video and audio signals from cameras 230, 231, 232, and microphones 240, 241, 242 of second environment 200 are output to processor 250, which may tag, encode and compress the signals for transmission to processor 150, which in turns decodes and decompresses the signals, and provides the decoded and decompressed signals to displays and speakers in first environment 100. Recorded media source 260, which may be, by way of example, a personal computer or other media player located in or controlled from within second environment 200 provides an output signal to processor 250. Processor 250 suitably tags, encodes, compresses and transmits the signal from recorded media source 260.

Processor 150 may cause each of video display devices 110, 112, 114 to have appearing thereon an individual located in second environment 200. By way of example, an individual located in front of camera 230 may appear on video display 110. The voice of an individual located in front of camera 230 may be detected by microphone 240 and output in phase by speakers 122, 123, collocated with display 110. Accordingly, the voice of the individual depicted on display 110 will have a directional quality indicating that the voice emanates from the same location as display 110. An individual located in front of camera 231 may appear on video display 112. The voice of an individual located in front of camera 231 may be detected by microphone 241 and output in phase by speakers 124, 125, collocated with display 112. Accordingly, the voice of the individual depicted on display 112 will have a directional quality indicating that the voice emanates from the same location as display 112. An individual located in front of camera 232 may appear on video display 114. The voice of an individual located in front of camera 232 may be detected by microphone 242 and output in phase by speakers 126, 127, collocated with display 114. Accordingly, the voice of the individual depicted on display 114 will have a directional quality indicating that the voice emanates from the same location as display 114.

A portion of the signal received by processor 150 is the compressed and encoded signal from recorded media source 260. Processor 150 may decode and decompress the signal, identify the portion of the received signal that constitutes an audio signal originating from the recorded media source 260, and cause the audio signal to be output to one or more speakers in first environment 100 in a manner so as to appear not to emanate from an individual depicted on a display. The audio signal may be provided so that the audio output from the signals does not provide a directional presence. By way of example, processor 150 may process the so-identified audio signal to render the signal an out-of-phase stereo signal. Processor 150 may then output the out-of-phase stereo signal to speakers in first environment 100, such as to one or more pairs of speakers in first environment 100. The resulting output sound does not provide a directional presence. Similarly, a portion of the signal received by processor 250 is the compressed and encoded signal from recorded media source 160. Processor 250 may decode and decompress the signal, identify the portion of the signal that corresponds to the audio signal from recorded media source 160, and cause the audio signal to be output to one or more speakers in second environment 200 in a manner so as to appear not to emanate from an individual depicted on a display. By way of example, the audio signal may be provided in a manner that does not provide a directional presence. By way of example, processor 250 may process the so-identified audio signal to render the audio signal an out-of-phase stereo signal. Processor 250 then outputs the out-of-phase stereo signal to one or more speakers in second environment 200.

Processor 150 may output an audio signal from recorded media source 260 as an out-of-phase stereo signal to speakers 120, 121. Processor 150 may also output a video portion of the signal from recorded media source 260 to display 116.

Microphone 310 is provided for an individual who may not be in either first environment 100 or second environment 200. This individual may be, for example, someone who provides services related to system 10, such as a helpdesk attendant. Microphone 310 provides an output signal of the voice of the individual. In the arrangement depicted in FIG. 1, the output signal is provided to processor 150 and processor 250. The signal may be transmitted over the same communications link, or a separate communications link, from the signals between processors 150, 250. Processor 150 then processes the signal, and causes the audio signal to be output to one or more speakers in first environment 100 in a manner so as to appear not to emanate from an individual depicted on a display. The audio signal may be provided so that the audio output from the signals does not provide a directional presence. By way of example, processor 150 may process the audio signal to render the signal an out-of-phase stereo signal. Processor 150 may provide the out-of-phase stereo signal to speakers in first environment 100, such as to one or more pairs of speakers in first environment 100. Processor 250 similarly processes the signal from microphone 310, to cause the audio signal to output to one or more speakers in second environment 200 in a manner so as to appear not to emanate from an individual depicted on a display. The audio signal may be provided by processor 250 so that the audio output from the signal does not provide a directional presence. By way of example, processor 250 may process the audio signal to render the signal an out-of-phase stereo signal, which is then provided to one or more pairs of speakers in second environment 200.

Any suitable communications link and communications protocol may be employed between processor 150 and processor 250. By way of example, a TCP/IP communications protocol may be employed.

Recorded media source 320 is provided, as a source of media which is not associated with either first environment 100 or second environment 200. Recorded media source 320 may provide an output data stream, which includes at least audio, and may include audio and video, to both first processor 150 and second processor 160. The output data stream may be stored in a compressed format on recorded media source 320, and may be transmitted in a compressed format, such as an MPEG format, to first processor 150 and second processor 160. Alternatively, an uncompressed data stream from recorded media source 320 may be compressed and encoded by a suitable processor associated with recorded media source 320. First processor 150 may decompress the data stream from recorded media source 320, and provide the audio portion of the data stream to one or more speakers in first environment 100 in a manner so as to appear not to emanate from an individual depicted on a display. The audio portion may be provided so that the audio output from the speakers does not provide a directional presence. By way of example, processor 150 may process the audio portion to provide the audio portion in the form of an out-of-phase stereo signal to one or more pairs of speakers in first environment 100. Second processor 250 may decompress the data stream from recorded media source 320, and provide the audio portion of the data stream to one or more speakers in second environment 200 in a manner so as to appear not to emanate from an individual depicted on a display. The audio portion may be provided so that the audio output from the speakers does not provide a directional presence. By way of example, processor 250 may process the audio portion to provide the audio portion in the form of an out-of-phase stereo signal to one or more pairs of speakers in second environment 200.

The functions of first processor 150 may be performed by a single processor, or may be performed by multiple processors. For example, compression, decompression, encoding, decoding, and routing to suitable speakers and video displays, may each be performed by distinct processors. Similarly, the functions of second processor 250 may be performed by a single processor, or may be performed by multiple processors.

The term “processor” as used herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., a computer program or software incorporating code) from memory and decodes and executes the instructions, calling on the ALU when necessary. “Memory”, as used herein, refers generally to one or more devices capable of storing data, such as in the form of chips, tapes, disks or drives. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of example only. Memory may take the form of a hard disk or a CD-ROM, by way of further example. Memory may be internal or external to an integrated unit, e.g. an integrated circuit (IC), including a processor.

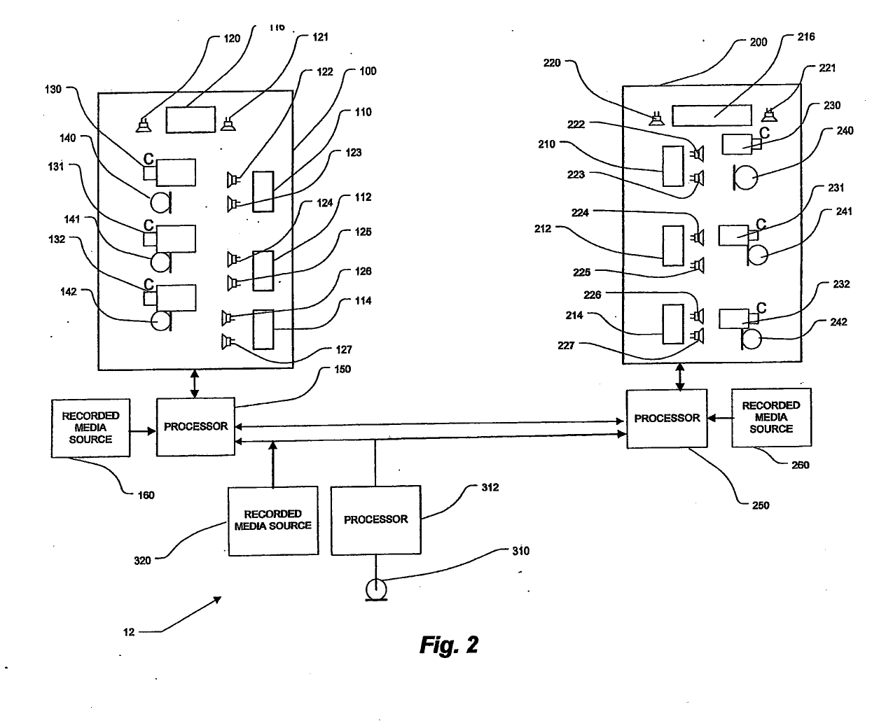

Referring now to FIG. 2, a system 12 is illustrated which is identical to the system 10 of FIG. 1, with the exception that the signal output by microphone 310 is provided to processor 312 which is collocated with microphone 310. Processor 312 processes the signal from microphone 310 and provides the signal so as to appear not to emanate from an individual depicted on a display. The signal may be provided so that the audio output from the speakers does not appear to emanate from a displayed image of a participant, and, by way of example, in a manner that does not provide a directional presence. By way of example, processor 312 may process the signal to provide the signal in the form of an out-of-phase stereo signal to processors 150, 250. Processors 150, 250 then output the out-of-phase stereo signals, which are then provided to one or more pairs of speakers in first environment 100 and second environment 200, respectively.

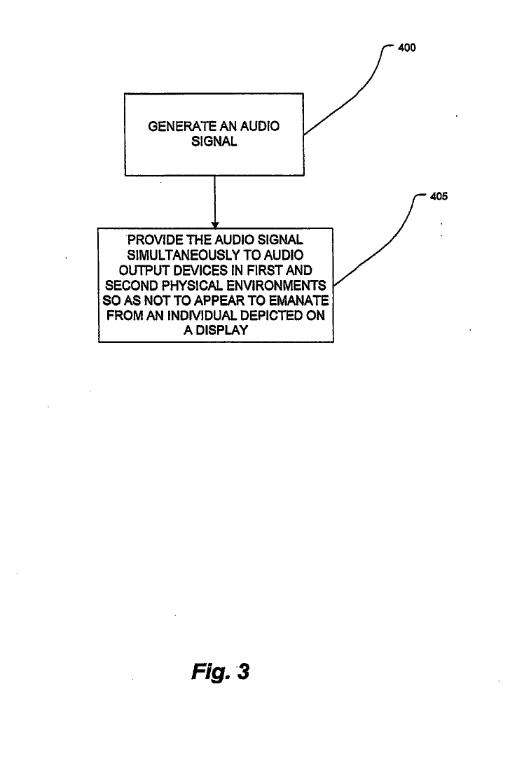

Referring now to FIG. 3, a process flow according to an embodiment will be explained. In a first step, an audio signal is received, as indicated by block 405. By way of example, processor 150 or processor 250 may receive an audio signal from a local recorded media source, or both processor 150 and processor 250 may receive an audio signal from a microphone. The audio signal is provided to speakers in the environments so as to appear not to emanate from an individual depicted on a display in either first environment 100 or second environment 200, as indicated by block 410.

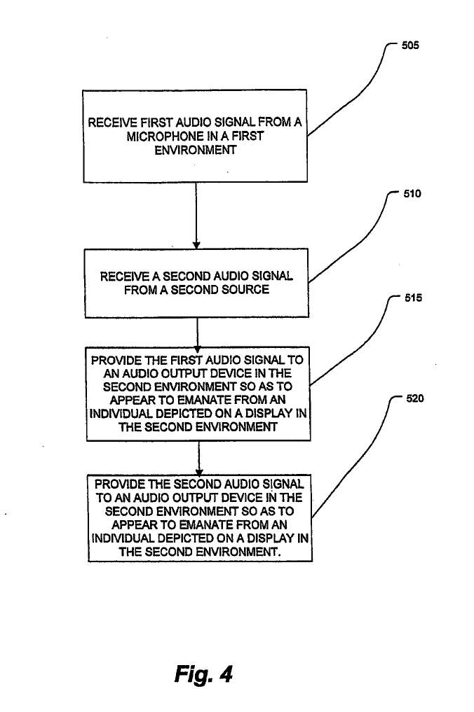

Referring now to FIG. 4, a process flow according to an alternative embodiment will be explained. A first audio signal is received from a first source, which includes a microphone in a first environment, as indicated by block 505. A second audio signal is received from a second source, as indicated by block 510. The first audio signal is provided to one or more audio output devices in a second environment in a manner so that the audio output appears to emanate from a displayed image of an individual in the second environment, as indicated by block 515. The second audio signal is provided to one or more audio output devices in the second environment in a manner so that the audio output does not appear to emanate from a displayed image of an individual in the second environment, as indicated by block 520.

In an embodiment, an audio output may be provided so as to appear not to emanate from an individual depicted on a display by being directionally linked with a visual element other than an image of an individual. The audio output may be directionally linked with a visual element other than an image of an individual during a teleconference, for example. The audio output may be directionally linked with a visual element such as an icon during a teleconference, while audio output from an individual at a remote location who is depicted on a display may be directionally linked with the displayed image of the individual.

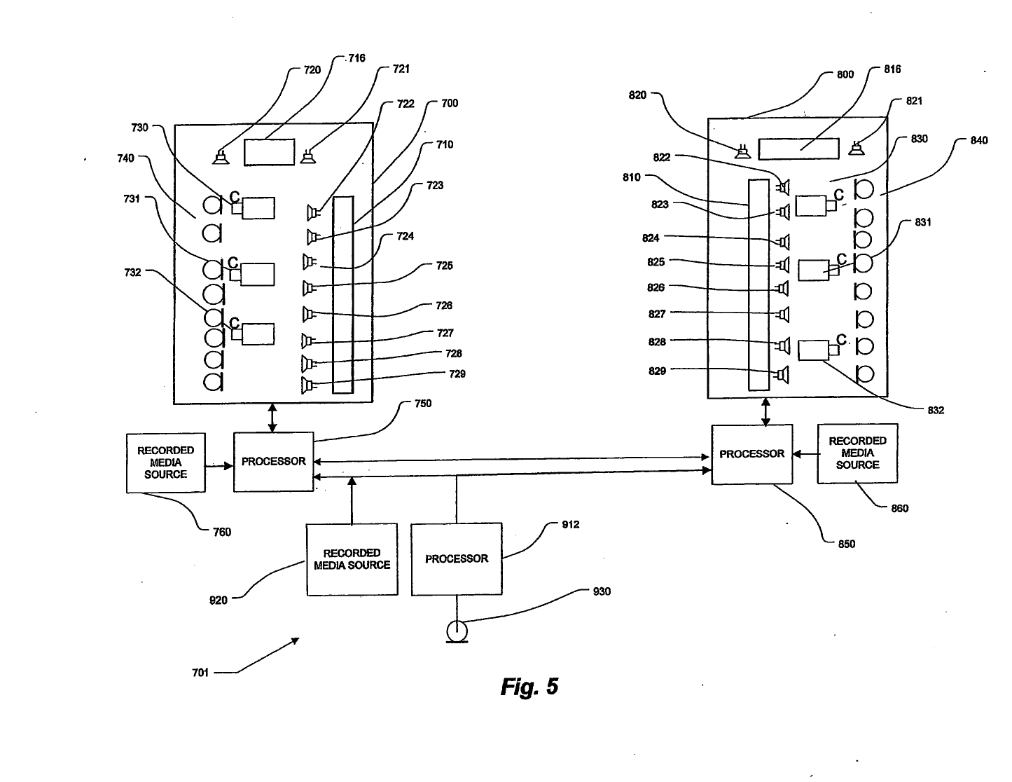

Referring now to FIG. 5, there is shown an embodiment of a video conferencing system 701. System 701 is generally similar to system 10 of FIG. 1, and provides video conferencing between first environment 700 and second environment 800. First and second environments 700 and 800 may be spaces suitable for human occupation, and may be rooms. First environment 700 and second environment 800 are configured for video conferencing among an indeterminate number of people in each environment. First environment 700 has a video display screen 710, with an associated speaker array 721. First environment 700 also includes video cameras 730, 731, 732, and an array 740 of microphones. First environment 700 also includes a further video display 716 with associated speakers 720, 721.

Similarly, second environment 800 has a video display screen 810 and an associated array of speakers 822, 823, 824, 825, 826, 827, 828, 829. Second environment 800 has three cameras 830, 831, 832, and an array of microphones 840. Second environment 800 further has a video display 216, and associated speakers 820, 821.

Display screens 710, 716, 810, 816 may be various forms of display apparatus, such as liquid crystal or gas discharge display panels, projection displays, or cathode-ray tube (CRT) displays. The provided speakers may be any type of audio speaker. The cameras may be any type of video camera, and may include digital video cameras which output a stream of data defining uncompressed frames of video in digital format. It will be appreciated that the numbers of display screens, speakers and microphones are exemplary, and that more or fewer of each may be provided. It will also be appreciated that two environments are exemplary, and that additional environments may be provided.

In video conferencing, video display device 810 may have appearing thereon an image of an individual located in first environment 700. The voice of the individual whose image appears on video display device 810 may be detected by one or more microphones in array 740 located so as to detect sounds emanating from the field of view of the cameras 730, 731, 732. The voice may then be output by selected ones of the speakers in second environment 800, so as to provide the impression to persons in second environment 800 that the voice is emanating from the same, or substantially the same, location as the image. The signal for the individual's voice may be provided as a signal other than an out-of-phase stereo signal. The signal for the individual's voice may be output as an in phase stereo signal.

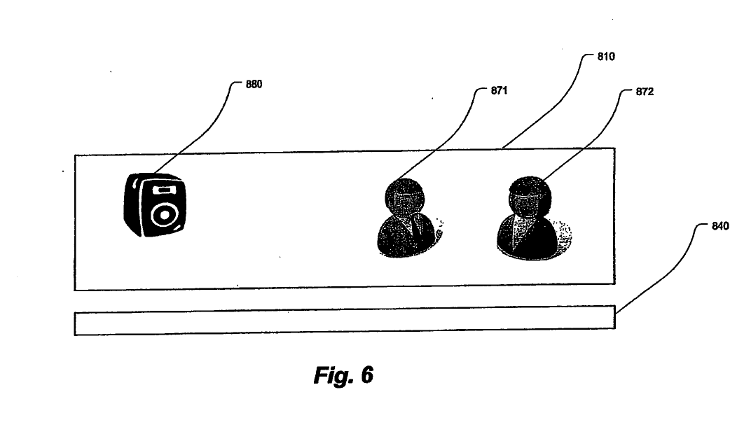

The processors, such as processor 850, may cause a display to display an icon or other visual element not associated with an image detected by one of the cameras. Referring now to FIG. 6, display 810 of FIG. 5 is shown schematically from the front, along with speaker array 840. An image 871 of an individual, who is in environment 700, is shown. An image 872 of a second individual, who is in environment 700, is also shown. Processor 850 may cause an icon 880 to be displayed when audio received from, for example, recorded media source 760 or recorded media source 860 is displayed. An icon may be displayed that is associated with the output of audio from a recorded media source. Speaker array 840 provides an audio output, which may be provided so as to be directionally associated with icon 880. By way of example speaker array 890 may provide an audio output from recorded media source 760 of FIG. 5 so as to be directionally associated with icon 880. By way of alternative example, an icon or wording may be displayed when audio from microphone 930 is displayed. For example, if microphone 930 is located at the location of a helpdesk operator, then the wording “helpdesk,” may be displayed, and speaker array may provide an audio output directionally associated with the displayed wording.

The system and method described above may be implemented, by way of example, in a video conference between or among participants interacting via a desktop or laptop computer system. In such an implementation, the processor of the desktop or laptop computer system performs the functions of such processors as processor 150, processor 250 described above with respect to the exemplary embodiment of FIG. 1. In such an embodiment, each environment may include only those speakers, microphones and cameras associated with the single computer system, which may be one or more speakers, microphones, and cameras.

It will be appreciated that the embodiments described and illustrated herein are merely exemplary.

What is claimed is:

1. A method of providing an audio signal to an audio output device, comprising:
receiving an audio signal;
providing the audio signal simultaneously to audio output devices in first and second physical environments so as to appear not to emanate from an individual depicted on a display in either said first environment or said second environment.

2. The method of claim 1, wherein said step of providing the audio signal comprises providing the audio signal as an out-of-phase stereo signal.

3. The method of claim 1, wherein said step of receiving an audio signal comprises receiving an audio signal from a microphone.

4. The method of claim 1, wherein said step of receiving an audio signal comprises receiving an audio signal from recorded media.

5. The method of claim 1, wherein the first and second physical environments are rooms.

6. The method of claim 1, wherein each of said physical environments comprises a plurality of audio output devices, and at least one video display.

7. The method of claim 6, wherein said at least one video display has portrayed thereon an image of an individual, the voice of the individual being output by said audio output devices to cause the voice to appear to a person in the physical environment to be associated with a location of the individual on said at least one video display.

8. The method of claim 1, wherein said step of providing comprises providing said audio signal to processors associated with each of said physical environments, and processing said audio signal by said processors to obtain an out-of-phase stereo signal.

9. A method of providing an audio signal, comprising the steps of:
receiving a first audio signal from a first source comprising a microphone in a first environment;
receiving a second audio signal from a second source;
providing the first audio signal to an audio output device in the second environment so as to appear to emanate from an individual depicted on a display in the second environment;
providing the second audio signal to an audio output device in the second environment so as to appear not to emanate from an individual depicted on a display in the second environment.

10. The method of claim 9, wherein said step of providing the second audio signal to an audio output device in the second environment comprises providing the second audio signal as an out-of-phase stereo signal.

11. The method of claim 9, wherein said step of providing the second audio signal to an audio output device in the second environment comprises providing the second audio signal so as to appear to emanate from an icon depicted on a display in the second environment.

12. The method of claim 9, wherein the second source comprises recorded media.

13. The method of claim 9, wherein the second source comprises a microphone not located in the first environment.

14. The method of claim 12, wherein said second audio signal comprises an out-of-phase stereo signal when received.

15. The method of claim 12, further comprising the step of processing said second audio signal to obtain an out-of-phase stereo signal.

16. A system for providing an audio signal to an audio output device, comprising:
a first audio signal source;
a second audio signal source comprising a microphone in a first environment;
first processor for receiving a first audio signal from the first source, and for providing the first audio signal to at least one audio output device in said first environment so as to provide audio output that does not appear to emanate from substantially the same location as an image of an individual on a display in said first environment;
second processor for receiving the first audio signal and for providing the first audio signal to at least one audio output device in the second environment in a manner to provide an audio output that does not appear to emanate from substantially the same location as an image of an individual on a display in said second environment, and for receiving the second audio signal and for providing the second audio signal, to at least one audio output device in a second environment in a manner to provide an audio output that does not appear to emanate from substantially the same location as an image of an individual on a display in said second environment.

17. The system of claim 16, wherein said first audio signal source comprises a microphone.

18. The system of claim 16, wherein said first audio signal source comprises a source of stored media.

19. The system of claim 18, wherein said source of stored media comprises a computer.

20. The system of claim 16, further comprising a third audio source comprising a microphone in said second environment, said second processor being further for receiving and transmitting a third audio signal from said third source, and said first processor being further for receiving the third audio signal from said second processor and providing the third audio signal, in a manner other than out-of-phase stereo, to at least one audio output device in the first environment.
